(19) United States
(12) Patent Application Publication
(10) Pub. No.: US 2013/0052878 A1
(43) Pub. Date: Feb. 28, 2013

(54) MICRO USB CONNECTOR

(71) Applicants: Chia-Ho CHANG, Taipei (TW); Yuan-Bin Tang, Taipei (TW)

(72) Inventors: Chia-Ho CHANG, Taipei (TW); Yuan-Bin Tang, Taipei (TW)

(21) Appl. No.: 13/306,053

(22) Filed: Nov. 29, 2011

(30) Foreign Application Priority Data
Aug. 26, 2011 (TW) 100216043

(51) Int. Cl. H01R 24/28

(52) U.S. Cl. 439/660

(57) ABSTRACT

A Micro Universal Serial Bus (USB) 3.0 connector includes a Micro USB 3.0 receptacle and a Micro USB 3.0 plug. The Micro USB 3.0 receptacle includes a third terminal group disposed at an insulating base, and the third terminal group includes a plurality of third contact ends. When perpendicular projection is performed, a predetermined distance is formed between the third contact ends and the first contact ends. The Micro USB 3.0 plug includes a third connection terminal group disposed at the insulating base, and the third connection terminal group includes a plurality of third connection ends. When perpendicular projection is performed, a predetermined distance is formed between the third connection ends and the first connection ends. Therefore, the Micro USB 3.0 connector is formed, which has more than two types of connector terminal specifications for plugging and connecting uses.

### CROSS-REFERENCES TO RELATED APPLICATIONS

This non-provisional application claims priority under 35 U.S.C.§119(a) on Patent Application No. 100216043 filed in Taiwan, R.O.C. on 2011 Aug. 26, the entire contents of which are hereby incorporated by reference.

### BACKGROUND OF THE INVENTION

1. Technical Field

The present invention relates to a Micro Universal Serial Bus (USB) 3.0 connector, and more particularly to a Micro USB 3.0 connector of a non-USB specification which provides an additional connection.

2. Related Art

Te transmission capacity of an USB connectors has increased dramatically over time, from the initial USB 1.0 specification to the current USB 3.0 specification. Due to its advantages such as plug-and-play and high-speed transmission, the USB connector has been widely applied to various electronic products.

According to different specifications and types, micro connectors are categorized into an A/B type (Type A/B, Mini A/B, and Micro A/B Type), and applied to various small electronic products, such as: a mobile phone, a digital camera, a card reader, a game console, a video recorder apparatus and a portable hard disk, so as to integrate more functions for use. In such applications the integral height of the Micro USB interface is low, so the Micro USB has become=mainstream in many novel smart mobile phones and Personal Digital Assistants (PDAs).

Currently, various different electronic devices have been developed to assist a user, including a display, a computer, a camera, and a plug-and-play device (a flash drive). However, in order to read data of the electronic devices or obtain a signal connection, the electronic devices must each have a corresponding assorted connector, and connector types of the various electronic devices are all different, such as: USB series and HDMI series, DIIVA series, E-SATA series, Display port series, SD series (SD, SDHC, SDXC), MS series (MS Pro Duo, MSHG Pro Duo, MSXC Pro Duo, Micro MS, Micro MSHG, Micro MSXC), MMC series (MMC, RS-MMC, MMC Plus, RS-MMC Plus, MMC Micro), CF series (I, II), XD series (XD, SMC) or SIM series. These connectors can each only be connected with a specific corresponding connector, so multiple connection wires with different connectors are provided.

However, currently many electronic devices are disposed with a Micro USB 3.0 connector, while other types of connectors are disposed on respective devices. Consequently, the problem that the Micro USB 3.0 connector and other connectors cannot be more effectively used is must be studied and solved by manufacturers engaged in this field.

### SUMMARY

In view of this challenge, the present invention provides a Micro USB 3.0 receptacle, which includes: an insulating base, including a plurality of tongues; a first terminal group, disposed at the insulating base, and including a plurality of first contact ends located at a first tongue; a second terminal group, disposed at the insulating base, and including a plurality of second contact ends located at a second tongue; and a third terminal group, disposed at the insulating base, and including a plurality of third contact ends, in which when perpendicular projection is performed, a predetermined distance is formed between the third contact ends and the first contact ends.

The present invention also provides a Micro USB 3.0 plug, which includes: an insulating base, including a plurality of grooves; a first connection terminal group, disposed at the insulating base, and including a plurality of first connection ends located at a first groove; a second connection terminal group, disposed at the insulating base, and including a plurality of second connection ends located at a second groove; and a third connection terminal group, disposed at the insulating base, and including a plurality of third connection ends, in which when perpendicular projection is performed, a predetermined distance is formed between the third connection ends and the first connection ends.

The present invention also provides a Micro USB 3.0 connector, which includes: a Micro USB 3.0 receptacle and a Micro USB 3.0 plug. The Micro USB 3.0 receptacle includes a third terminal group, disposed at an insulating base, and including a plurality of third contact ends, in which when perpendicular projection is performed, a predetermined distance is formed between the third contact ends and the first contact ends. The Micro USB 3.0 plug includes a third connection terminal group, disposed at the insulating base, and including a plurality of third connection ends, in which when perpendicular projection is performed, a predetermined distance is formed between the third connection ends and the first connection ends, so as to form the Micro USB 3.0 connector which has more than two types of connector terminal specifications for plugging and connecting uses.

In the present invention, the third terminal group and the third connection terminal group are disposed on the Micro USB 3.0 receptacle and the Micro USB 3.0 plug respectively, so as to provide a connector different from an ordinary Micro USB 3.0 connector into which only a Micro USB 3.0 interface can be plugged. In the present invention, the third terminal group and the third connection terminal group may correspondingly conform to terminal specifications such as standard HDMI, DVI, VGA, and SATA, so as to form a single Micro USB 3.0 connector which has more than two types of connector terminal specifications for plugging and connecting uses.

### BRIEF DESCRIPTION OF THE DRAWINGS

The present invention will become more fully understood from the detailed description given herein below for illustration only, and thus not limitative of the present invention, wherein:

FIG. 1 is a schematic exploded view (I) of a first embodiment of the present invention;

FIG. 2 is a schematic exploded view (II) of the first embodiment of the present invention;

FIG. 3 is a schematic exploded view (I) of a second embodiment of the present invention;

FIG. 4 is a schematic exploded view (II) of the second embodiment of the present invention;

FIG. 5 is a schematic exploded view of a third embodiment of the present invention;

FIG. 6 is a schematic exploded perspective view of the third embodiment of the present invention;

FIG. 7 is a schematic view of perpendicular projection of A-A′ in FIG. 6;

FIG. 8 is a schematic view of perpendicular projection of B-B′ in FIG. 6; and

FIG. 9 is a schematic side sectional view of the third embodiment of the present invention.

### DETAILED DESCRIPTION

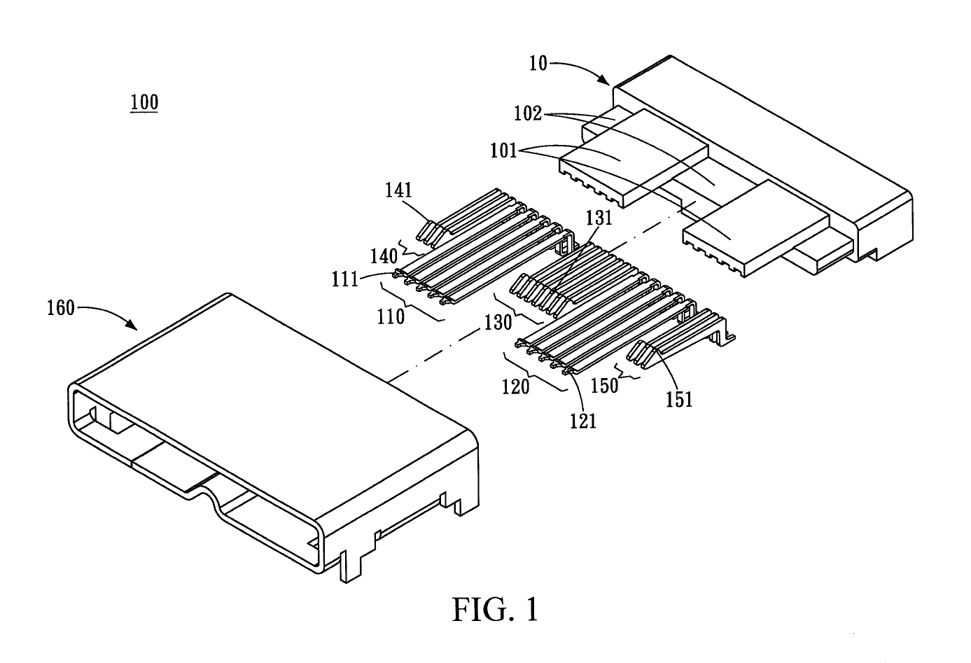

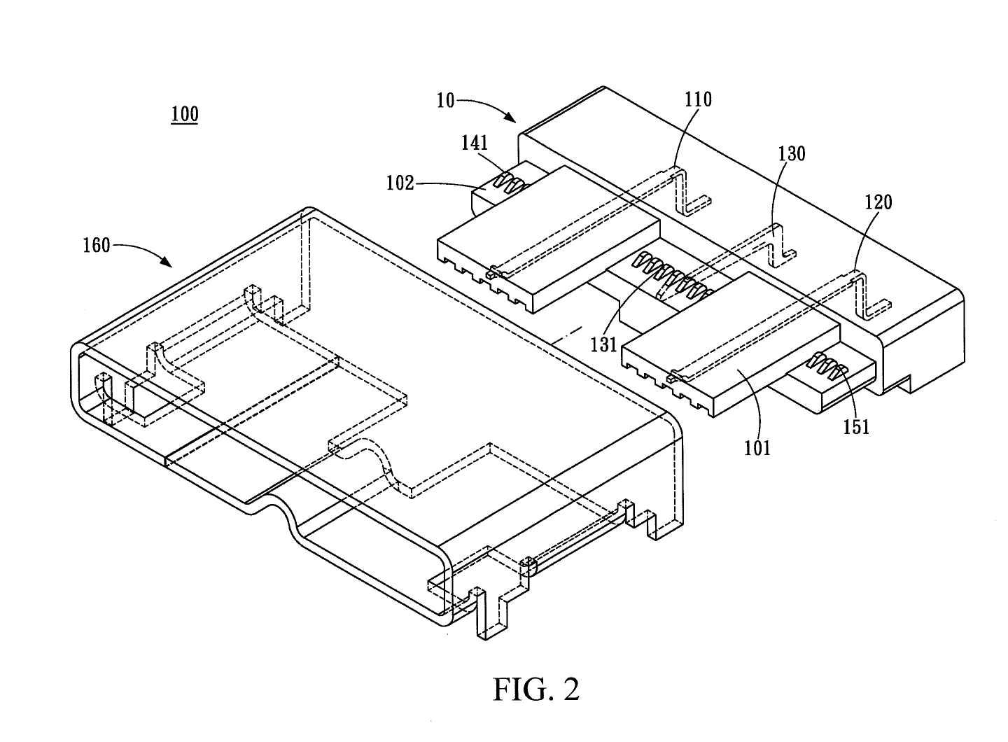

Please refer to FIG. 1 and FIG. 2, in which a first embodiment of the present invention is shown; FIG. 1 is a schematic exploded view (I), and FIG. 2 is a schematic exploded view (II).

The drawings of the first embodiment disclose a Micro USB 3.0 receptacle 100, which may be any one of Micro A/B Types, and the Micro USB 3.0 receptacle 100 includes an insulating base 10, a first terminal group 110, a second terminal group 120, and a third terminal group 130.

The insulating base 10 includes a plurality of tongues 101. This embodiment takes a design of two tongues 101 formed in parallel to each other as an example, the two tongues 101 both protrude out of the insulating base 10, and preferably the two tongues 101 have the same length and width. Here the insulating base 10 further includes a support base 102 located below the two tongues 101, and the support base 102 protrudes out of the insulating base 10, is shorter than the two tongues 101, and is used to dispose a plurality of third contact ends 131 of the third terminal group 130. The structural form and the dimension of the support base 102 are not limited herein. During practical use, the support base 102 may be omitted, the volume of the insulating base 10 is directly enlarged, and the plurality of third contact ends 131 may also be disposed on the insulating base 10.

The first terminal group 110 is disposed at the insulating base 10, and may be combined with the insulating base 10 through embedding and injection molding, or combined with the insulating base 10 in a separate assembly manner. The first terminal group 110 includes a plurality of first contact ends 111, located at a lower surface of a first tongue 101 and in an exposed state.

The second terminal group 120 is disposed at the insulating base 10, and may be combined with the insulating base 10 through embedding and injection molding, or combined with the insulating base 10 in a separate assembly manner. The second terminal group 120 includes a plurality of second contact ends 121, located at a lower surface of a second tongue 101 and in an exposed state.

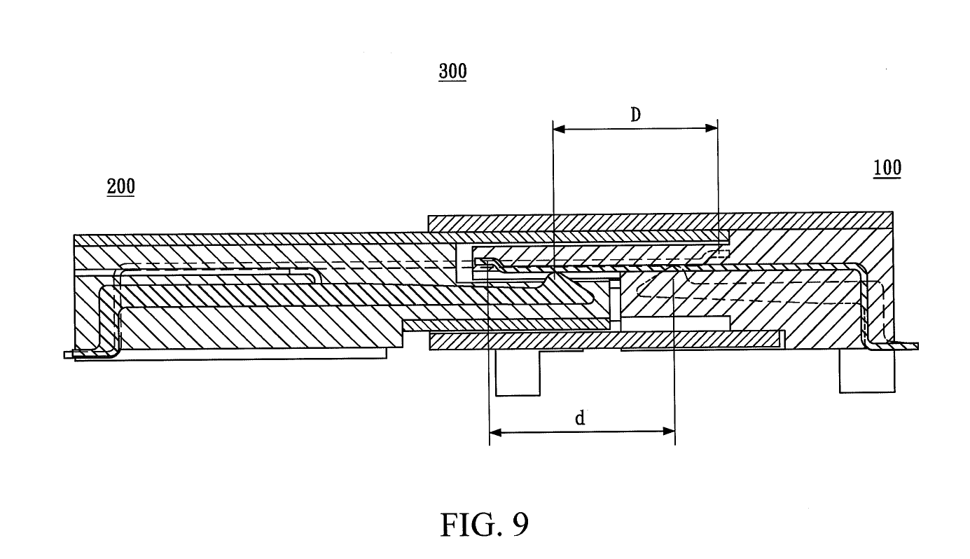

The third terminal group 130 is disposed at the insulating base 10, and may be combined with the insulating base 10 through embedding and injection molding, or combined with the insulating base 10 in a separate assembly manner. The third terminal group 130 includes a plurality of third contact ends 131. In this embodiment, the plurality of third contact ends 131 is disposed between the first terminal group 110 and the second terminal group 120, but the present invention is not limited thereto. The plurality of third contact ends 131 may also be disposed at a lateral end of the insulating base 10 and is only adjacent to one of the first terminal group 110 and the second terminal group 120. When perpendicular projection is performed, that is, a cross section of any terminal of the first terminal group 110, the second terminal group 120, and the third terminal group 130 is projected, a first predetermined distance D is formed between the third contact ends 131 and the first contact ends 111 (as shown in FIG. 9).

The Micro USB 3.0 receptacle 100 of this embodiment further includes a fourth terminal group 140, disposed at the insulating base 10, and including a plurality of fourth contact ends 141. When perpendicular projection is performed in a manner the same as that for the aforementioned third terminal group 130, a second predetermined distance D is formed between the fourth contact ends 141 and the first contact ends 111 (as shown in FIG. 9).

The Micro USB 3.0 receptacle 100 of this embodiment further includes a fifth terminal group 150, disposed at the insulating base 10, and including a plurality of fifth contact ends 151. When perpendicular projection is performed in a manner the same as that for the aforementioned third terminal group 130, a third predetermined distance D is formed between the fifth contact ends 151 and the first contact ends 111 (as shown in FIG. 9).

Specifically, the first predetermined distance D may be greater than, smaller than, or equal to the second predetermined distance D or the third predetermined distance D, and the second predetermined distance D may also be greater than, smaller than, or equal to the third predetermined distance D.

The fourth terminal group 140 and the fifth terminal group 150 are added to the Micro USB 3.0 receptacle 100 of this embodiment, the fourth terminal group 140 and the fifth terminal group 150 are located at two outer sides of the insulating base 10 respectively, and here the volume of the whole Micro USB 3.0 receptacle 100 is relatively enlarged.

The first terminal group 110 conforms to a terminal specification for transmitting USB 2.0 signals, the first terminal group 110 and the second terminal group 120 conform to a terminal specification for transmitting USB 3.0 signals, and the third terminal group 130 conforms to a terminal specification for transmitting non-USB 3.0 signals. The third terminal group 130 may be applicable to an HDMI connector, a DVI connector, a VGA connector, or an SATA connector, but the present invention is not limited thereto.

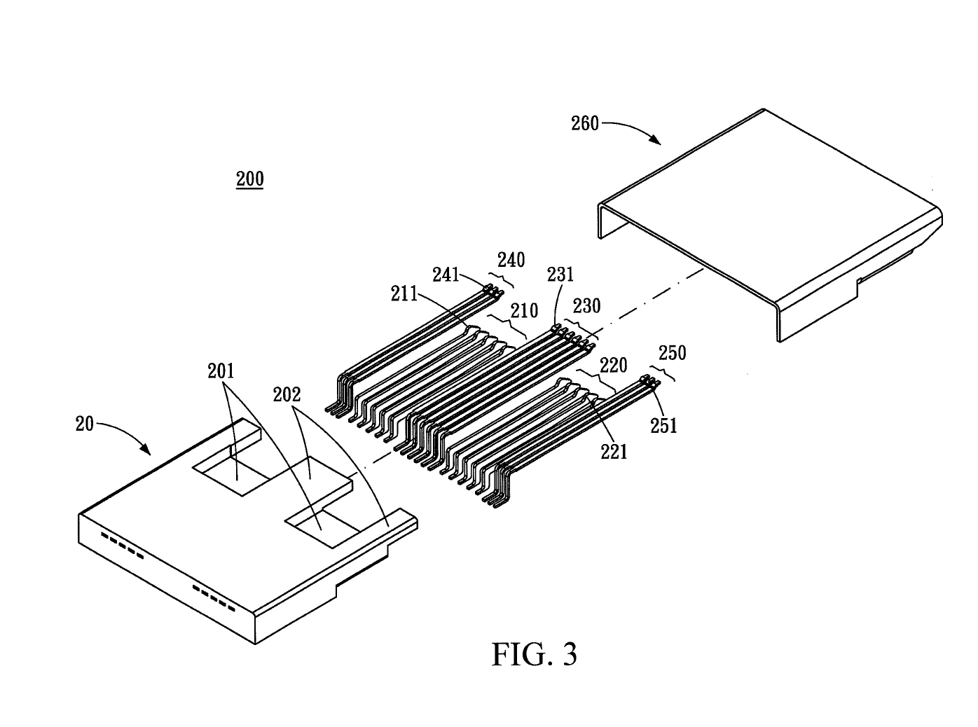

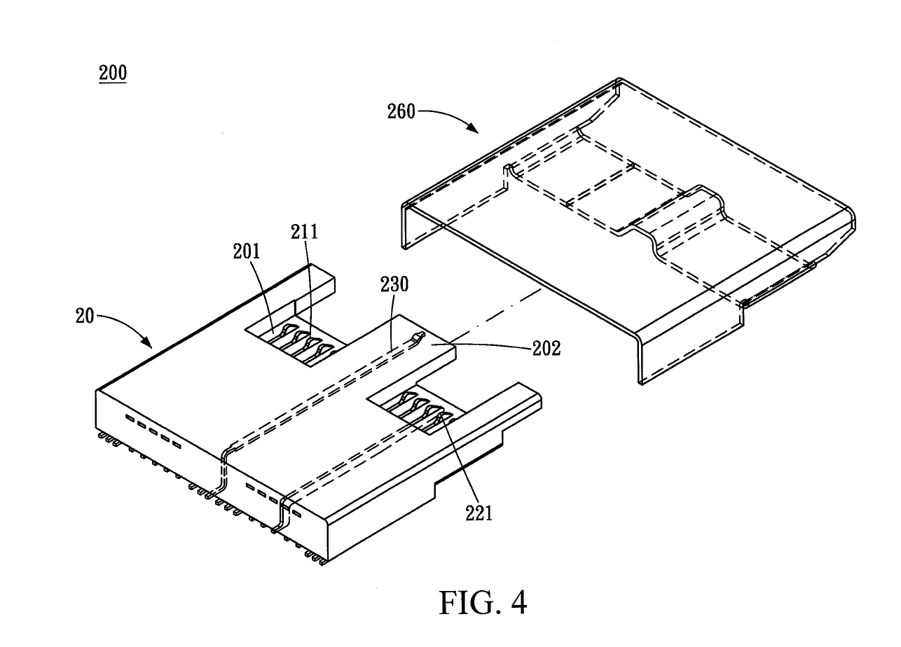

Please refer to FIG. 3 and FIG. 4, in which a second embodiment of the present invention is shown, FIG. 3 is a schematic exploded view (I), and FIG. 4 is a schematic exploded view (II). Here the greatest difference between the second embodiment and the first embodiment lies in that, the first embodiment is the Micro USB 3.0 receptacle 100, while the second embodiment is a Micro USB 3.0 plug 200 inserted into the Micro USB 3.0 receptacle 100.

The drawings of the second embodiment disclose a Micro USB 3.0 plug 200, which may be any one of Micro A/B Types, and the Micro USB 3.0 plug 200 includes an insulating base 20, a first connection terminal group 210, a second connection terminal group 220, and a third connection terminal group 230.

The insulating base 20 includes a plurality of grooves 201. This embodiment takes a design of two grooves 201 formed with a common depth and in parallel to each other as an example, the two grooves 201 are both recessed inward at the insulating base 20, and preferably the two grooves 201 have the same length and width. Here the insulating base 20 further includes an extension base 202 located above the two grooves 201. The extension base 202 protrudes out of the insulating base 20, is longer than the two grooves 201, and is used to dispose a plurality of third connection ends 231 of the third connection terminal group 230. When the grooves 201 are used in practice, the volume of the insulating base 20 is directly enlarged, the grooves 201 are recessed inward, and the plurality of third connection ends 231 is disposed at inner surfaces of the grooves 201.

The first connection terminal group 210 is disposed at the insulating base 20, and may be combined with the insulating base 20 through embedding and injection molding, or combined with the insulating base 20 in a separate assembly manner. The first connection terminal group 210 includes a plurality of first connection ends 211, located at an inner surface of a first groove 201 and in an exposed state.

The second connection terminal group 220 is disposed at the insulating base 20, and may be combined with the insulating base 20 through embedding and injection molding, or combined with the insulating base 20 in a separate assembly manner. The second connection terminal group 220 includes a plurality of second connection ends 221, located at an inner surface of a second groove 201 and in an exposed state.

The third connection terminal group 230 is disposed at the insulating base 20, and may be combined with the insulating base 20 through embedding and injection molding, or combined with the insulating base 20 in a separate assembly manner. The third connection terminal group 230 includes a plurality of third connection ends 231. In this embodiment, the plurality of third connection ends 231 is disposed at the extension base 202 between the first connection terminal group 210 and the second connection terminal group 220, but the present invention is not limited thereto. The plurality of third connection ends 231 may also be disposed at a lateral end of the insulating base 20 and is only adjacent to one of the first connection terminal group 210 and the second connection terminal group 220. When perpendicular projection is performed, that is, a cross section of any terminal of the first connection terminal group 210, the second connection terminal group 220, and the third connection terminal group 230 is projected, a fourth predetermined distance d is formed between the third connection ends 231 and the first connection ends 211 (as shown in FIG. 9).

The Micro USB 3.0 plug 200 of this embodiment further includes a fourth connection terminal group 240, disposed at the insulating base 20, and including a plurality of fourth connection ends 241. When perpendicular projection is performed in a manner the same as that for the aforementioned third connection terminal group 230, a fifth predetermined distance d is formed between the fourth connection ends 241 and the first connection ends 211 (as shown in FIG. 9).

The Micro USB 3.0 plug 200 of this embodiment further includes a fifth connection terminal group 250, disposed at the insulating base 20, and including a plurality of fifth connection ends 251. When perpendicular projection is performed in a manner the same as that for the aforementioned third connection terminal group 230, a sixth predetermined distance d is formed between the fifth connection ends 251 and the first connection ends 211 (as shown in FIG. 9).

Specifically, the fourth predetermined distance d may be greater than, smaller than, or equal to the fifth predetermined distance d or the sixth predetermined distance d, and the fifth predetermined distance d may also be greater than, smaller than, or equal to the sixth predetermined distance d.

The first connection terminal group 210 is of a type conforming to a standard USB 2.0 terminal specification, the first connection terminal group 210 and the second connection terminal group 220 are of a type conforming to a standard USB 3.0 terminal specification, and the third connection terminal group 230 is of a type conforming to a non-standard USB 3.0 terminal specification. The third connection terminal group 230 may be applicable to an HDMI connector, a DVI connector, a VGA connector, or an SATA connector, but the present invention is not limited thereto.

The fourth connection terminal group 240 and the fifth connection terminal group 250 are added to the Micro USB 3.0 plug 200 of this embodiment, the fourth connection terminal group 240 and the fifth connection terminal group 250 are located at two outer sides of the insulating base 20 respectively, and here the volume of the whole Micro USB 3.0 plug 200 is relatively enlarged.

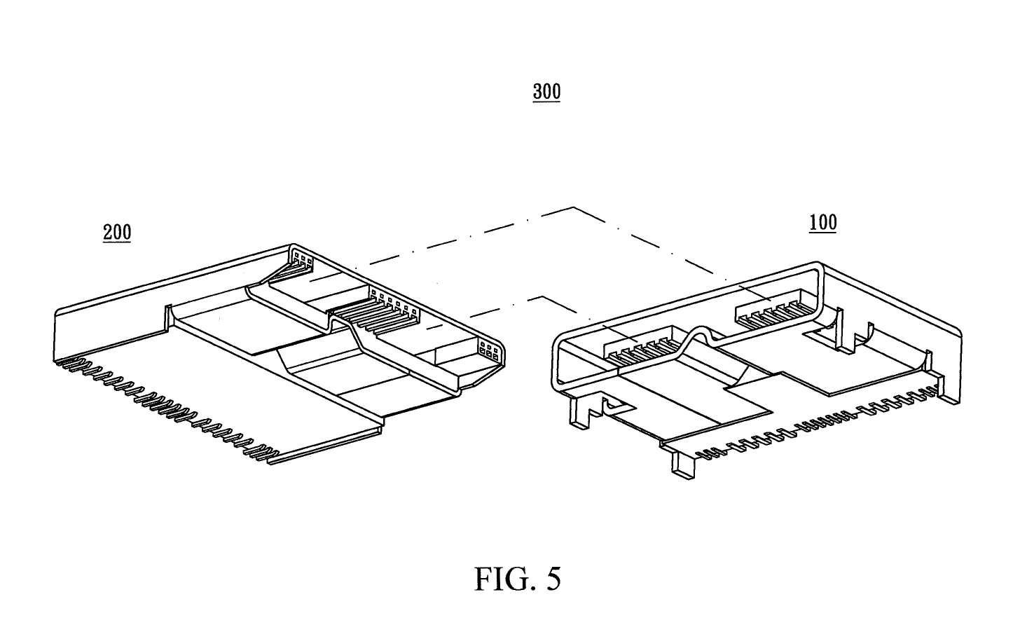

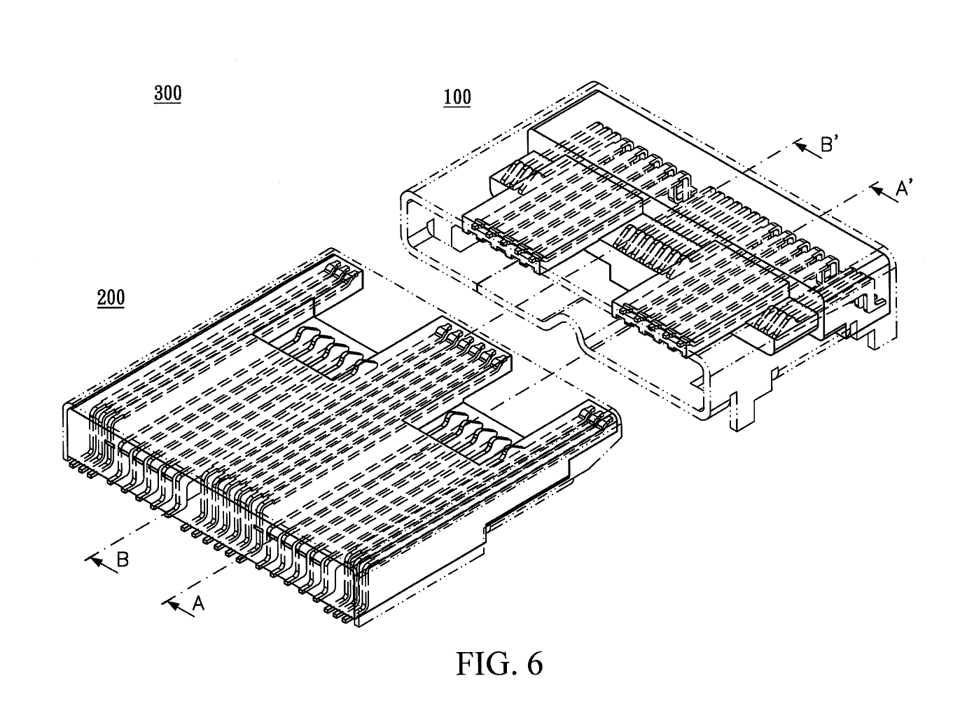

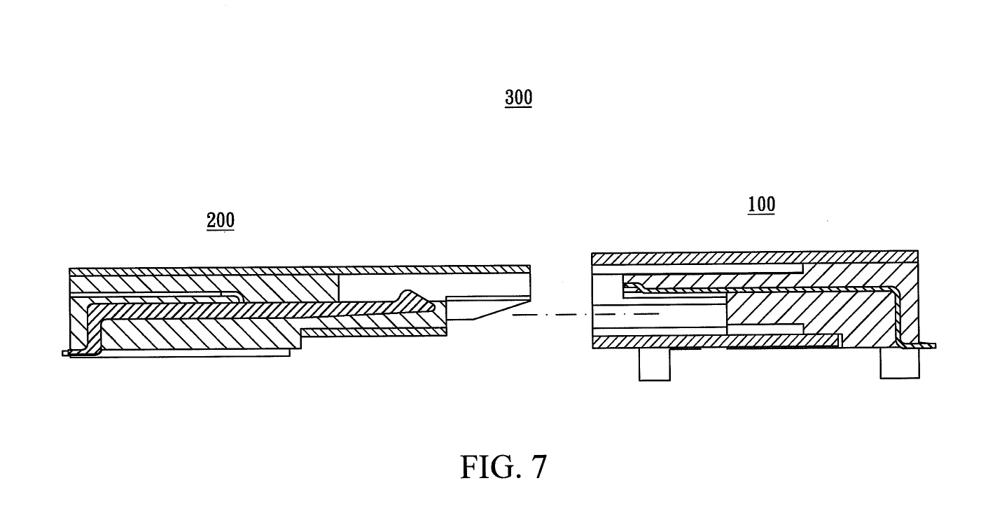

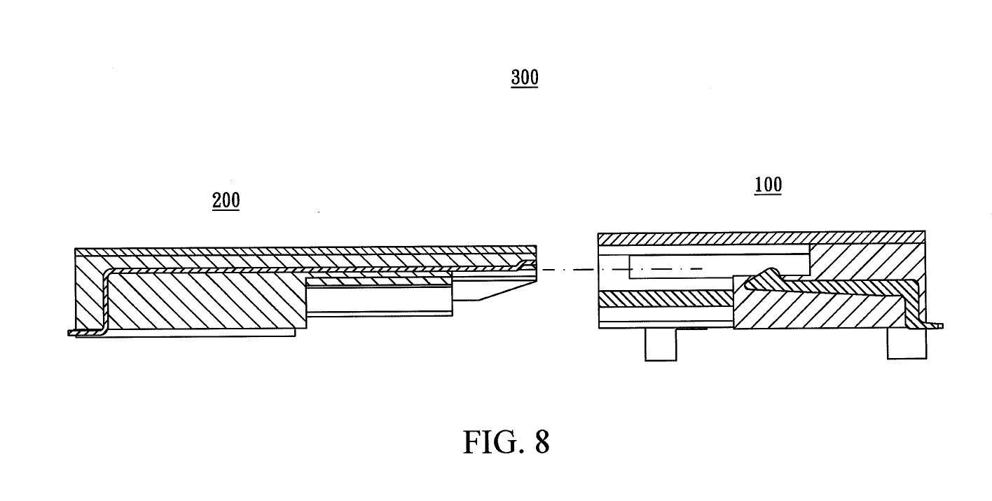

Please refer to FIG. 5, FIG. 6, FIG. 7, FIG. 8, and FIG. 9, in which a third embodiment of the present invention is shown. In this embodiment, a connection is made for disclosing the first embodiment and the second embodiment, so as to form a combination of a Micro USB 3.0 connector 300.

When the Micro USB 3.0 plug 200 and the Micro USB 3.0 receptacle 100 are connected, the plurality of grooves 201 is respectively connected to the plurality of tongues 101, the plurality of first connection ends 211 is electrically connected to the plurality of first contact ends 111, the plurality of second connection ends 221 is electrically connected to the plurality of second contact ends 121, and the plurality of third connection ends 231 is electrically connected to the plurality of third contact ends 131.

In the present invention, the third terminal group and the third connection terminal group are disposed on the Micro USB 3.0 receptacle and the Micro USB 3.0 plug respectively, so as to provide a connector different from an ordinary Micro USB 3.0 connector into which only a Micro USB 3.0 interface can be plugged. In the present invention, the third terminal group and the third connection terminal group may correspondingly conform to terminal specifications such as standard HDMI, DVI, VGA, and SATA, so as to form a single Micro USB 3.0 connector which has more than two types of connector terminal specifications for plugging and connecting uses.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

1. A Micro Universal Serial Bus (USB) 3.0 receptacle, comprising:
an insulating base, comprising a plurality of tongues;
a first terminal group, disposed at the insulating base, and comprising:
a plurality of first contact ends, located at a first tongue;
a second terminal group, disposed at the insulating base, and comprising:
a plurality of second contact ends, located at a second tongue; and
a third terminal group, disposed at the insulating base, and comprising:
a plurality of third contact ends, wherein when perpendicular projection is performed, a first predetermined distance is formed between the third contact ends and the first contact ends.

2. The Micro USB 3.0 receptacle according to claim 1, wherein the insulating base further comprises a support base for disposing the third contact ends of the third terminal group.

3. The Micro USB 3.0 receptacle according to claim 1, further comprising a fourth terminal group, disposed at the insulating base, and comprising a plurality of fourth contact ends, wherein when perpendicular projection is performed, a second predetermined distance is formed between the fourth contact ends and the first contact ends.

4. The Micro USB 3.0 receptacle according to claim 1, further comprising a fifth terminal group, disposed at the insulating base, and comprising a plurality of fifth contact ends, wherein when perpendicular projection is performed, a third predetermined distance is formed between the fifth contact ends and the first contact ends.

5. The Micro USB 3.0 receptacle according to claim 1, wherein the first terminal group and the second terminal group comprise terminals for transmitting USB 3.0 signals.

6. The Micro USB 3.0 receptacle according to claim 1, wherein the third terminal group comprises terminals for transmitting non-USB 3.0 signals.

7. A Micro Universal Serial Bus (USB) 3.0 plug, connected to the Micro USB 3.0 receptacle, and comprising:
an insulating base, comprising a plurality of grooves;
a first connection terminal group, disposed at the insulating base, and comprising:
a plurality of first connection ends, located at a first groove;
a second connection terminal group, disposed at the insulating base, and comprising:
a plurality of second connection ends, located at a second groove; and
a third connection terminal group, disposed at the insulating base, and comprising:
a plurality of third connection ends, wherein when perpendicular projection is performed, a fourth predetermined distance is formed between the third connection ends and the first connection ends.

8. The Micro USB 3.0 plug according to claim 7, wherein the insulating base further comprises an extension base for disposing the third connection ends of the third connection terminal group.

9. The Micro USB 3.0 plug according to claim 7, further comprising a fourth connection terminal group, disposed at the insulating base, and comprising a plurality of fourth connection ends, wherein when perpendicular projection is performed, a fifth predetermined distance is formed between the fourth connection ends and the first connection ends.

10. The Micro USB 3.0 plug according to claim 7, further comprising a fifth connection terminal group, disposed at the insulating base, and comprising a plurality of fifth connection ends, wherein when perpendicular projection is performed, a sixth predetermined distance is formed between the fifth connection ends and the first connection ends.

11. The Micro USB 3.0 plug according to claim 7, wherein the first connection terminal group and the second connection terminal group comprise terminals for transmitting USB 3.0 signals.

12. The Micro USB 3.0 plug according to claim 7, wherein the third connection terminal group comprises terminals for transmitting non-USB 3.0 signals.

13. A Micro Universal Serial Bus (USB) 3.0 connector, comprising:
a Micro USB 3.0 receptacle according to claim 1 and a Micro USB 3.0 plug connected to the Micro USB 3.0 receptacle, the Micro USB 3.0 plug comprising:
an insulating base, comprising a plurality of grooves;
a first connection terminal group, disposed at the insulating base, and comprising:
a plurality of first connection ends, located at a first groove;
a second connection terminal group, disposed' at the insulating base, and comprising:
a plurality of second connection ends, located at a second groove; and
a third connection terminal group, disposed at the insulating base, and comprising:
a plurality of third connection ends, wherein when perpendicular projection is performed, a fourth predetermined distance is formed between the third connection ends and the first connection ends, wherein
the grooves are connected to the tongues respectively, the first connection ends are electrically connected to the first contact ends, the second connection ends are electrically connected to the second contact ends, and the third connection ends are electrically connected to the third contact ends.
